(19) United States
(12) Patent Application Publication
(10) Pub. No.: US 2020/0060289 A1
(43) Pub. Date: Feb. 27, 2020

(54) Method for Applying a Powder Insect Repellent Composition

(71) Applicants: Hemant N. Joshi, Parsippany, NJ (US); Amitkumar N. Lad, New Milford, NJ (US)

(72) Inventors: Hemant N. Joshi, Parsippany, NJ (US); Amitkumar N. Lad, New Milford, NJ (US)

(21) Appl. No.: 16/665,573

(22) Filed: Oct. 28, 2019

Related U.S. Application Data
(62) Division of application No. 15/230,401, filed on Aug. 6, 2016.

(51) Int. Cl. A01N 65/06; A01N 65/00; A01N 65/26; A01N 65/08; A01N 25/12

(52) U.S. Cl. CPC A01N 65/06; A01N 65/00; A01N 65/26; A01N 65/08; A01N 25/12; Y02A 50/342; Y02A 50/327; Y02A 50/34; Y02A 50/345; Y02A 50/344; Y02A 50/346

(57) ABSTRACT

Disclosed is a method for repelling insects from the skin of a subject that reduces the absorption of insect repellent into the skin. The method includes the step of topically applying a powder insect repellent composition to the skin of the subject. The powder insect repellent composition may include solid particles of talc, calcium silicate, and/or cyclodextrin. The powder insect repellent composition may include natural oils, DEET, and/or paricidin as active ingredients. The powder insect repellent composition may also include antihistamine and/or a colorant.

### RELATED APPLICATION

This application is a division of and claims priority from our co-pending U.S. patent application Ser. No. 15/230,401 “Composition of a Novel Topical Insect Repellent Powder Formulation” filed Aug. 6, 2016, which priority application is incorporated by reference as if fully set forth herein.

### FIELD OF THE DISCLOSURE

The present disclosure discloses compositions of novel topical powder formulations with insect repellent activity. The compositions of the formulations are more safe and having substantive mosquito repellent effect. The disclosure also relates to special methods for preparing these compositions.

### BACKGROUND OF THE DISCLOSURE

There are several kinds of insects and bugs with wings, which bother human-beings and animals. Some insects, such as mosquitoes, bite us to suck blood. The sucking insects include the common gnats (e.g., Aedes, Culex and Anopheles species), moth gnats (Phlebotomi), biting gnats (Culicoides species), sandflies (Simulium species), biting flies (e.g., Stomoxys calcitrans), tsetse flies (Glossina species), horseflies (Tabamis, Haematopota and Chrysops species), houseflies (e.g., Musca domestica and Fannia canicularis), flesh-flies (e.g., Sarcophaga camaria), myiasis-causing flies (e.g., Lucilia cuprina, Chysom chloropyga) etc.

There are hundreds of types of mosquitoes and the compositions in this patent application have potential to be effective against all the species of mosquitoes observed in the world. There are three common genera in mosquitoes—Anopheles, Aedes and Culex. Mosquito menace is a global problem. Bites of mosquitoes are responsible for the transmission of significant tropical diseases like Malaria, Filariasis, Dengue fever, Yellow fever, Japanese encephalitis, Chikungunya, Ross river virus, Burma forest virus, Zika virus, Murray Valley encephalitis etc. are known to spread through mosquitoes. Dengue, also known as Dengue hemorrhagic fevers, threatens an estimated 2.5 billion people and an estimated 50 million people contract the disease per year. Around 500,000 dengue patients, most of whom are children, require hospitalization each year and around 2.5% of those affected die. Another serious tropical disease, which threatens about 1 billion people in 80 countries is Filariasis or Elephantiasis. This disease already affects an estimated 120 million people and severely incapacitates and deforms 40 million people worldwide. Despite the existence of effective vaccine, there are an estimated 200,000 cases of Yellow fever and approximately 30,000 deaths attributed to this disease each year. The Zika virus can make anyone sick for up to a week with fever, rash, joint pain, red eyes, and other symptoms. It's especially dangerous to women who are pregnant or considering pregnancy because it increases the risk of babies born with microcephaly, a condition marked by an abnormally small head and incomplete brain development. The search of Chemical Abstracts on mosquito repellents containing plant-derived essential oils revealed over hundred active patents mostly from Asia, which include Chinese, Japanese and Korean language patents and those of India (in English) accounted for roughly ¾ of all patents. In general, these patents describe repellent compositions for use in topical agents, cosmetic products, incense, coils, fumigants, indoor and outdoor sprays, mat, fibers, textiles among other applications [Pohlit Am et al., Planta Med. 2011 April; 77(6):598-617].

There are more than 3,500 species of mosquitoes. Both male and female mosquitoes feed mainly on fruit and plant nectar, but only female mosquitoes bite to humans and animals because females need a protein(s) in blood to help her eggs develop. Once she sucks up enough blood, she rests for a couple of days before laying her eggs. The mosquito goes through four separate and distinct stages of its life cycle: Egg, Larva, Pupa, and Adult. Each of these stages can be easily recognized by its special appearance. Usually, the eggs are deposited in clusters—called rafts—on the surface of stagnant water, or they are laid in areas that flood regularly. Eggs can hatch in as little as an inch of standing water. Females will lay eggs up to three times before they die. Eggs spend their first 10 days in water. Water is necessary for the eggs to hatch into larvae, called wigglers. Wigglers feed on organic matter in stagnant water and breathe oxygen from the surface. They develop into pupae, which do not feed and are partially encased in cocoons. Over several days, the pupae change into adult mosquitoes. [Sources: The American Mosquito Control Association; the U.S. Centers for Disease Control].

There several patents on mosquito repellent formulations. They are based on the actives used in the formulations and the delivery systems. The actives in such formulation can be either synthetic chemicals or natural insect repellents.

Patent application WO 2001076373 A1 describes the preparation of an incense stick formulation, which can be useful as herbal mosquito repellent. Formulation comprises an effective amount of the essential oil of Tagetes minuta, Cedar, Chrysanthemum cinerariaefolium (Pyrethrum powder) and Cyperus rotundus powder together with binders and fillers.

U.S. Pat. No. 4,816,256 describes the mosquito repellent compositions comprising an active agent and an oil-soluble, water insoluble acrylate polymer having specific solubility parameters of approximately 6-10 (cal/cc)^{1/2} in poorly hydrogen bonding solvents.

U.S. Pat. No. 5,885,600 describes a composition that has insect repellent properties. The composition can be made into lotions, creams or sprays for application to mammals and vegetation, or it can be formed into polymeric sheets, which in turn can be formed into various useful articles, such as animal collars, garbage bags, or planting material. The composition is made from cold processed extracted oils and an antioxidant, particularly from a combination of Neem, Citronella and Cedar wood oils.

An alcohol-free insect repellent composition includes lemongrass oil, essential oil of lemon eucalyptus, rose geranium oil, litsea cubeba oil, the balance of the insect repellent composition to 100 weight % being water; wherein the insect repellent composition is free of non-naturally occurring ingredients has been described in US 20130084347 A1. The formulation is long lasting and does not feel like a sticky coating when sprayed onto human skin.

Indian patent 209799 describes the novel herbal mosquito repellent compositions comprising extracts of Blumea lacera, which are prepared by solvent extraction and also by steam distillation. Herbal mosquito repellent formulation prepared in liquid, vapor and mat form. Polymer bounded compositions for slow release are also prepared.

Patent WO2005007140 claims a composition containing an insect repellent, an antihistaminic compound, a topical anesthetic and an anti-inflammatory compound. This way, it repels harmful insects and treats symptoms developed at the site bitten by the insects.

The applicants used many synthetic insect repellents. Picaridin and DEET (N,N-diethyl-m-toluamide) are most commonly used synthetic actives. In a trial in Pakistan and Afganistan, soaps loaded with DEET were supplied and the incidence of Malaria decreased significantly (Trop Med Int Health 9: 335-42, 2004). U.S. Pat. No. 6,441,034 B 1 uses DEET as active and delivered in a gel form prepared using water, lower alcohol, a gelling agent, triethanol amine, methyl and propyl paraben and a perfume. U.S. Pat. No. 7,846,464 describes an insect repellent composition comprising (a) lemongrass oil; (b) p-menthane-3,8 diol; (c) vanillin; and (d) a delivery vehicle. The delivery vehicle contained mineral oil, ethanol, dipropylene glycol, isoparaffinic hydrocarbon, and isononyl acetate.

A recent US patent application 2016/0000955, inventors combined insect repellents and odor-reducing compositions. They used Picaridin in combination with zinc ricinoleate (the zinc salt of 12-hydroxy-9-cis-octadecenoic acid). The activity of DEET and picaridin has been reported to be due to olfactory sensing. They have been shown to be effective against ticks and flies. In this patent, they added the odor reducing agent to mask the distinctive odors of these actives. Zinc ricinoleate is a well-known odor-reducing compound that acts by adsorbing or sequestering odor-active compounds, and is particularly effective with nitrogen and sulfur compounds of relatively low molecular weight.

U.S. Pat. No. 6,180,127 discloses a slow release formulation of DEET, which contained a copolymer of polyvinyl pyrrolidone and an alkyl group of 4-30 carbons. The formulations are characterized by high residual action, low skin penetration and high resistance to removal by water.

Most of the synthetic mosquito repellents are toxic to human body. DEET was developed by the US military as an insect repellent in 1946. It has a broad spectrum activity and repels most mosquitoes, flies, chiggers, fleas and ticks. DEET is absorbed through skin and the rate and extent of absorption depends upon age, body mass, formulation composition and ethanol amount in the formulation, body temperature, sweating etc. DEET in the form of creams, lotions, gels penetrate easily through skin. Following removal of DEET from the surface of the skin, the remaining product absorbed in the dermal region continues to absorb. The toxicity of DEET depends upon the route of exposure and the dose. Excessive dermal application of DEET over large areas of body and over a period of days to weeks can cause severe toxicity including neurotoxicity.

It is important to develop formulations, which provides surface exposure of such products but provide minimal systemic absorption. Thus, the safety aspects of such products must be evaluated carefully. The current formulation has been developed to make the product safer with low toxicity. Creams, ointments, solutions, lotions, sprays are known to alter the integrity of the skin layers due to surfactants and other excipients incorporated in the formulations, thereby increasing the permeation of actives (in this patent application—insect repellents) through skin. These formulations spread uniformly over the skin creating a close contact with the skin surface. A portion of actives is absorbed in the body when applied as a cream or a spray, and that portion is not available to act as an insect repellent reducing its efficacy. The portion of insect repellents absorbed in the skin is also not available for efficacy. For this reason, we chose powder delivery system as a mosquito repellent. Powder being in a solid form, does not alter the integrity of skin layers. It stays on the surface and allows full effect of insect repellency. Only a portion of particles is in touch with the skin, thereby reducing the contact area and so also, the absorption of active. In creams, ointments, solutions, lotions and sprays, the actives are adsorbed on the surface of powder particles or get absorbed inside the particles. This way, less percentages of actives are easily available for absorption through the skin compared to other formulations. These actives are therefore available to repel mosquitoes or insects. Apart from an increased efficacy, the powder delivery system also reduces absorption of actives from the skin

### SUMMARY OF THE DISCLOSURE

Disclosed is a method for repelling insects from the skin of a subject comprising the step of topically applying a powder insect repellent composition to the skin of the subject.

The powder insect repellent composition in an embodiment may include at least one of the following: talc, calcium silicate, and cyclodextrin.

The powder insect repellent composition in an embodiment may include talc present in a concentration of from about 0.01% to about 95% w/w and/or calcium silicate present in a concentration of from about 0.01% to about 40% w/w, and/or cyclodextrin in a concentration of from about 0.01% to about 40% w/w.

The powder insect repellent composition in an embodiment may include an insect repellent that is a natural oil, and may include a number of different insect repellents that are each a natural oil.

The powder insect repellent composition in an embodiment may include DEET and/or picaridin

The powder insect repellent composition in an embodiment may include solid powder particles coated with at least one liquid insect repellent. The solid powder particles may in possible embodiments be at least one of the following: talc, calcium silicate, and cyclodextrin. In variant embodiments the solid powder particles may make up from about 0.01% to about 40% w/w of the powder insect repellent composition. The liquid insect repellent may be a natural oil, DEET, and/or picaridin. Variant embodiments may include at least one of the following natural oils: mustard, eucalyptis, pine, peppermint, menthol, camphor, garlic, wintergreen, rose geranium, litsea cubeba, lemongrass, pulegone, oleoresin capsicum, neem, citronella, and catnip.

The powder insect repellent composition in possible embodiments includes an antihistamine.

The powder insect repellent composition in possible embodiments includes at least one of the following: a fragrance and a colorant.

The present disclosure proposes composition of a novel topical powder formulation as an insect repellent. Powder is a solid dosage form comprising of a large number of finely divided solid particles of drugs or mixture of drugs and excipients. A drug in a liquid form is adsorbed on a solid matrix such as calcium silicate and cyclodextrin. The key is to make the product effective in terms of insect repellency.

Another key objective is to provide a formulation that is not harmful to human beings.

Another objective is to provide a formulation, which will be an effective mosquito repellent for a long time.

The applicants accomplish this and the other objectives with a novel powder compositions, which could be sprinkled over or applied to human skin.

Another objective is to allow user to sprinkle or apply the powder formulation on cloths or covers or bed-sheets or sleeping bag, if the user is sleeping. If the user is outdoors, the powder insect repellent formulation is applied over exposed areas of the body in sufficient quantities.

The present disclosure is directed to a novel method for preparing an insect repellent composition, comprising the steps of: (a) mixing of actives and natural oils; (b) mixing of oils with alcohol; (c) mixing of all ingredients from step (a) and (b) with calcium silicate; (d) mixing of Talc and other ingredients; (e) mixing of ingredients from step (c) and (d); and (f) pass through a fine mesh sieve.

In another embodiment, the insect repellent formulation contains talc and calcium silicate. In another embodiment, the insect repellent formulation contains talc and cyclodextrin. In another embodiment, the insect repellent formulation contains talc, calcium silicate and cyclodextrin.

In other embodiment, the formulation also contains pine oil or others natural oils such as neem oil, eucalyptus oil, mustard oil or combinations thereof (0.01% to 10% w/w). Other natural insect repellents may also be used in concentration range of 0.01% to 10% w/w.

In another embodiment, the insect repellent formulation contains DEET as one of the actives (0.01% to 10% w/w).

In another embodiment, the insect repellent formulation contains Picaridin as one of the actives (0.01% to 10% w/w).

In another embodiment, the insect repellent formulation contains DEET and Picaridin as actives along with natural insect repellents (0.01% to 10% w/w for each). Other synthetic insect repellents may also be used in concentration range of 0.01% to 10% w/w.

The amount of talcin embodiments ranges from 0.01% to 95% w/w.

The amount of calcium silicate used in embodiments of this formulatins ranges from 0.01% to 40% w/w.

The amount of cyclodextrin in embodiments ranges from 0.01% to 40% w/w.

The amount of alcohol in the original composition ranges from 0 to 25 w/w. The alcohol is not present in the final formulation as it is dried off during the manufacturing process.

In another embodiment, the insect repellent formulation contains an anti-inflammatory agent in the range 0.01% to 6% w/w.

In another embodiment, the insect repellent formulation contains an anti-histaminic agent in the range 0.01% to 6% w/w.

### DETAILED DESCRIPTION

### Definition of Terms Used

Unless defined otherwise, all technical and scientific terms used herein have the same meanings as commonly understood by one of ordinary skill in the art.

As used herein and in the claims, the singular forms “a”, “an”, and “the” include plural reference unless the context clearly dictates otherwise. For example, reference to “an excipient” is a reference to one or more excipients and equivalents thereof known to those skilled in the art.

The term “about” is used to indicate that a value includes the standard level of error for the substance or method being employed to determine the value. The terms “comprise,” “have” and “include” are open-ended linking verbs. Any forms or tenses of one or more of these verbs, such as “comprises,” “comprising,” “has,” “having,” “includes” and “including,” are also open-ended.

The terms “treat,” “treated,” “treatment,” or “treating” used herein refers to a preventative measure to repel insects.

“Combination Therapy” is defined as the treatment wherein two or more active ingredients are co-administered to achieve special advantages over their individual therapeutic effects. They may produce a synergistic effect where the total therapeutic effect is greater than the sum of their therapeutic effects. Combination therapy may allow the use of lower doses of one or all the active ingredients used in the formulation.

An “Active Agent” is defined as the chemical substance, which shows a useful clinical effect when administered in appropriate doses and as a suitable dosage form. In this case, the clinical effect is to repel insects such as mosquitoes or flies.

An “Active Effective Amount” is defined as the amount of an active agent, which is effective for producing some desirable effect with a reasonable benefit/risk ratio applicable to a treatment.

“A Dosage Form” or “A Delivery System” is defined as a product developed to deliver actives to a desired site where the insect repellency action is needed. A “desired site” is an area where the insect repellency action is desired. These are insect products marketed for use, which contain one or more active ingredients and excipients. These are delivered onto human body by various methods and routes of administration. The route of application is topical administration. In this patent application, the desired site can be any other surface such as bed sheet, sleeping bag etc.

“Formulation Composition” of a dosage form lists all the ingredients in the formulation and their quantities. It does not describe the process of manufacturing the formulation.

An “Effective Composition” of a dosage form lists all the ingredients and their quantities, which provides a desired effect. The dosage form contains “effective amounts” of active ingredients.

“Excipients” are compounds used in the dosage form along with the active ingredient. The actives are expected to be stable in the dosage form along with the excipients throughout the shelf-life of the dosage form.

“Toxicologically Acceptable Materials” refers to those compounds or materials, which are suitable for use in contact with tissue or organs of humans and animals without excessive toxicity, irritation, allergic response or any other problems. Only toxicologically acceptable excipients are used in the formulations in this patent application.

“Chemical stability” with respect to the active agent means that an acceptable percentage of degradation products are produced by chemical pathways such as hydrolysis, thermal degradation or oxidation.

“Physical stability” with respect to the therapeutic agent means that an acceptable percentage of aggregates, loss of smell or generation of foul smell, loss of original color or discoloration, crystals, visible mold/fungus is formed.

The formulation is considered “stable” when it shows good chemical and physical stability.

The term “synthetic” insect repellent is considered when active substances or products are prepared by chemical synthesis in a laboratory or in a chemical manufacturing plant.

The term “natural” insect repellent is considered when the active substances exist in or formed by nature. The natural source, such as flowers, leaves, is directly used in the formulation or the actives are extracted using solvent and then the extract is used in the formulation

The term “insect” describes as an animal that have three pairs of legs, a segmented body divided into three regions (head, thorax, and abdomen), one pair of antennae and, usually, wings. Few insects such as ants, spiders have 8 legs.

The term “anti-histaminic component” describes as a drug or other compound that inhibits the physiological effects of histamine, used especially in the treatment of allergies.

The term “anti-inflammatory component” describes as a substance or compound that reduces inflammation or swelling.

A “fragrance” is defined as a compound which imparts sweet or pleasant scent. Fragrances can be either natural or synthetic. Active components of many of the natural fragrances have been identified and synthesized. Derivatives of natural chemicals have been prepared and are being used as synthetic fragrances. One uses combination of fragrances to produce a desired effect. The role of fragrances in this formulation is to mask the smell of various actives added and make the insect repellent pleasant.

Insect repellents are commonly used personal protection to avoid insect bites. As the word suggests, an “Insect repellent” formulation is the one when applied on the body or on the surrounding areas, the insects are repelled and insect do not land. If they happened to land, they are repelled from biting the subject. A “Powder insect repellent” formulation is the one which is a powder form. The powder applied over the surface where we desire an insect repellency action. As mentioned in the background information, mosquitoes can spread many serious diseases and the current formulations, in particular, can be used as mosquito repellents. Over the years, many mosquito repellent formulations such as cream, spray, coil, mat, incense and any more have been prepared. Some of the marketed products of mosquito repellent have been listed in Table 1. These formulations have several advantages and disadvantages based on the type of dosage form. Formulations like cream and spray are sometimes sticky to the skin and chances of absorption of mosquito repellent agent or other excipients present in the formulation is more. These formulations soften the skin and open the pores of skin. The actives from the formulations can be absorbed in the body. Formulations like coils and incense produce fumes, which may irritate eyes and lungs. Sometime, it is difficult to inhale or on ingestion of fumes can lead some serious allergic conditions. Also, synthetic agents used as mosquito repellent have serious health issues like eye and skin irritation, insomnia, mood disturbances, seizure, etc.

Cyclodextrin: Cyclodextrins (CD) are a family of compounds made up of sugar molecules bound together in a ring (cyclic oligosaccharides). Exposure of starch to an enzyme called cyclomaltodextrin glucanotransferase, naturally excreted by B. macerans, yields a mixture of six-, seven- and eight-member rings corresponding to α-CD, β-CD and γ-CD, respectively. For the purpose of this patent application, the cyclodextrin can be one or more the following—α-cyclodextrin (6 membered sugar ring molecule), β-cyclodextrin (7-membered sugar ring molecule), γ-cyclodextrin (8-membered sugar ring molecule), hydroxypropyl betacyclodextrin, sulfobutylether betacyclodextrin, and randomly methylated beta cyclodextrin.

Calcium Silicate: Calcium silicate is the chemical compound Ca₂SiO₄, also known as calcium orthosilicate and sometimes formulated 2CaO.SiO₂. It is one of a group of compounds obtained by reacting calcium oxide and silica in various ratios, e.g. 3CaO.SiO₂, Ca₃SiO₅; 2CaO.SiO₂, Ca₂SiO₄; 3CaO.2SiO₂, Ca₃Si2O₇ and CaO.SiO₂, CaSiO₃. Calcium silicate is a white free-flowing powder derived from limestone and diatomaceous earth.

Talc: Talc is a naturally occurring mineral, mined from the earth, composed of magnesium, silicon, oxygen, and hydrogen and having chemical composition of Mg₃Si₄O₁₀ (OH)₂ or H₂Mg₃ (SiO₃)₄. It has been used as filler, lubricant and glidant in the pharmaceutical formulations as well as in cosmetic formulations as abrasive, absorbent, anticaking agent, opacifying agent and skin protectant due to its high functionality. Following are the types of talc powder.
1. Talc Lump (SiO₂: 52%, MgO: 30%, whiteness: 80%).
2. Chemical grade talcum powder (SiO₂: 60% 1250-mesh or SiO₂: 60% 800-mesh).
3. Ceramic grade talcum powder (SiO₂: 50-55% 325-mesh, SiO₂: 55-60% 325-mesh, Talc Powder SiO₂: 60% 400-mesh).
4. Cosmetic grade talc powder (Whiteness: 90%-95%, SiO₂: 60%, MgO: 30%).
5. Pharmaceutical grade talcum powder (Whiteness: 90%, SiO₂: 60% 325-mesh) Food grade talcum powder (SiO₂: 60% 325-mesh).
7. Paper grade talcum powder (whiteness: 86% min-95% min, SiO₂: 35% min-60% min, MgO: 30% min).

Pine oil—Pine oil is a colorless to pale yellow essential oil. Depending on its source, pine oil may either have a fresh, earthy, and forest-like fragrance or a strong, dry, balsamic, turpentine-like odor. Pine oil can be obtained from various pine species such as Pinus sylvestris, Pinus pinaster, Pinus maritima, Pinus radiate, Pinus koraiensis, Pinus pumila, Pimus luchuensis, Pinus palustris, Pinus bungeana, Pinus thunbergii, Pinus densiflora, Pinus parviflora, Pinus pentaphylla, Pinus koraiensis, Pinus pumila, Pimus luchuensis, Pinus palustris or Pinus bungeana or a mixture of these. Pine oil is extracted through steam distillation of the needles, twigs and cones of the pine tree.

Mustard oil—The term mustard oil is used for two different oils that are made from mustard seeds: a fatty vegetable oil resulting from pressing the seeds, and an essential oil resulting from grinding the seeds, mixing them with water, and extracting the resulting volatile oil by distillation. Mustard oil has a typical pungent and sharp flavor. Mustard oil also has an antibacterial, antifungal, and anti-inflammatory action.

Eucalyptus oil—Eucalyptus oil is the generic name for distilled oil from the leaf of Eucalyptus tree. The leaves of selected eucalyptus are steam distilled to extract eucalyptus oil. Cineole-based eucalyptus oil is used as an insect repellent and biopesticide.

Neem oil—Neem oil is a vegetable oil pressed from the fruits and seeds of the neem (Azadirachta indica). For decades, neem oil has been used as an insect repellent.

Citronella oil—Citronella oil is one of the essential oils obtained from the leaves and stems of different species of Cymbopogon (lemongrass). Citronella oil is also a plant-based insect repellent and has been registered for this use in the United States since 1948.

Lemongrass oil—Lemongrass is also known by Cymbopogon and it is a genus of about 55 species of grasses. Cymbopogon essential oils and constituents present therein e.g. citral, geraniol, citronellol, citronellal and piperitone, have been known to possess impressive antibacterial, antifungal, antiyeast, insecticidal and insect repellent activities for a long time.

Geranium oil—Geranium oil obtained from species of Pelargonium graveolens. Geranium oil, taken from the flower of the same name, is part of a family of natural and effective insect repellents that include lemongrass and citronella oils.

Prallethrin—Prallethrin is a pyrethroid insecticide. Prallethrin 1.6% w/w liquid vaporizer is a repellent insecticide, which is generally used for the control of mosquitoes in the household. The World Health Organization published in 2004 that “Prallethrin is of low mammalian toxicity, with no evidence of carcinogenicity” and “is very toxic to bees and fish but of low toxicity to birds”.

DEET—DEET (chemical name N,N-diethyl-meta-toluamide) is used as the active ingredient in many insect repellents. Insect repellents that contain DEET offer the best protection against mosquito bites. DEET is designed for direct application to skin to repel insects, rather than kill them. Despite severe toxic properties, which can dramatically affect adults and children including allergic reaction, dermatitis, neurological and cardiovascular toxicity, the risk of toxic effects from DEET is considered slight. Nevertheless, DEET should always be used lowest effective dose possible.

Picaridin—Picaridin, also known as Icaridin (hydroxyethyl isobutyl piperidine carboxylate), is a compound found in many mosquito repellents used in Europe, Australia, Latin America, and Asia. Its chemical name is KBR 3023. Years of safe use of picaridin in other parts of the world attest to its safety and effectiveness.

The inventors attempted to overcome some of disadvantages of currently commercialized insect repellents by developing a novel topical powder formulation containing natural (essential oils) oils and synthetic compounds as mosquito repellent. Natural oils have been used in mosquito repellency for more than a century in much of the world and are the most widely used natural repellents today. Mosquito repellency is believed to be due to the synergistic interaction of the chemical components present in natural oil. Another key aspect of this disclosure is the use of cyclodextrin and calcium silicate. Calcium silicate is known for its CO₂ (carbon dioxide) absorbing properties. Female mosquitoes have olfactory (odor-sensing) organs called palps. These instruments are attuned to the odor of CO₂, which we produce every time we exhale. High concentrations of CO₂, which mosquitoes can detect from more than 150 feet away, offer an initial temptation to hungry mosquitoes. Hence calcium silicate is used here may act as a mosquito repellent by reducing the level of CO₂. [Source: US department of health and human service]. Also, the loading of oils in to powder is difficult. So, calcium silicate and cyclodextrin play an important role in loading oils in the powder formulation.

Microorganisms reside on human skin, mainly in the superficial layers of epidermis and upper parts of hair follicles. They are referred as skin microbiota. Skin flora is usually non-pathogenic, and either commensal (are not harmful to their host) or mutualistic (offer a benefit). Each person has different set of microorganisms. The benefits these microorganisms can offer include preventing transient pathogenic organisms from colonizing the skin surface, either by competing for nutrients, secreting chemicals against them, or stimulating the skin's immune system. These microorganisms produce and secrete their own chemicals or convert chemicals on our skin to other airborne chemicals. Mosquitoes can smell these chemicals and get attracted. That is the reason, some people get bitten by mosquitoes more than others. The formulations in this patent application has cyclodextrin. Cyclodextrins are bucket-shaped molecules in which chemical can get trapped due to complexation. When we sweat, the cyclodextrin in the formulation would dissolve in the sweat. Once in the dissolved state, cyclodextrin would absorb chemicals produced by microorganisms and the chemicals will not be air-borne. Once devoid of these chemical smell, the person will not attract mosquitoes. Thus, calcium silicate and cyclodextrin may be playing a role as an active apart from helping to load the oily actives in the powder formulation.

TABLE 1
Currently Marketed mosquito repellent formulations in the US.

| Type of | |
|---|---|
| formulation | Active Ingredient |
| Spray | 23.8% DEET |
| Lotion | 20% DEET |
| Spray | 6.65% DEET |
| Spray | Oil of lemon eucalyptus; |
| | p-menthane |
| | 3,8-diol (PMD) |
| Spray | 2% Soybean Oil |
| Spray | 4.75% DEET |
| Lotion, Towelettes, Spray | 7.5% IR3535 |
| Spray | 10% Citronella |
| Spray | 12% Citronella; 2.5% |
| | peppermint oil; 2% cedar |
| | oil; 1% lemongrass oil; |
| | 0.05% geranium oil |
| Spray | 10% Citronella; 2% |
| | peppermint oil |
| Towelettes, Spray | 5% Citronella |
| Lotion, Spray | 0.1% Citronella |
| Liquid solution | Active Ingredient not known |
| Lotion | 0.05% Citronella |
| Vapor based wristband | 9.5% DEET |
| Vapor based wristband | 9.5% DEET |
| Vapor based wristband | 25% Citronella |
| Vapor based liquid | Prallethrin 1.6% w/w |
| Vapor based liquid, | Prallethrin 1.6% w/w |
| coil, mat, paper | |
| Cream | DEET |
| Spray | — |
| Spray, candle, vapor | Citronella oil, eucalyptus |
| liquid, coil | oil, DEET |
| Patch (clothing) | Citronella oil |

Creams, ointments and solutions generally contain many penetration enhancers. They increase percutaneous absorption of actives by increasing the thermodynamic activity of the penetrant, thereby increasing the effective escaping tendency and concentration gradient of the diffusing species (Remington, 20^{th} Edition, Chapter 44, page 842). Some of the penetration enhancers are solvents, surfactants, and miscellaneous chemicals. Some of these increase the degree of hydration of stratum corneum or disrupts its lipoprotein matrix. Chemicals like water, ethanol, fatty acids, surfactants etc. increase permeation of active molecules, such as mosquito repellents in this case. The skin permeation in older people may be more compared to young people due to lesser diffusional resistance by stratum corneum. Consumption of alcohol makes the peripheral blood vessels relax to allow more blood to flow through the skin and tissues. The actives in the mosquito repellents diffused through the skin are taken away in the body increasing absorption of more actives from the mosquito repellents.

In other embodiment, natural oil or combination of oils are used. Commonly used oils are—eucalyptus, mustard, pine, peppermint, menthol, camphor, garlic, wintergreen (methyl salicylate), rose geranium, litsea cubeba, lemongrass, oil of penny royal (pulegone), oleoresin capsicum, catnip etc.

In an another embodiment, diphenhydramine hydrochloride is used as anti-histamine agent to avoid allergic reaction. Suitable salt of other antihistamines used in the formulation are selected from one or more of, but not limited to: triprolidine, pyrilamine, chlorcyclizine, carbinoxamine, tripelennamine, brompheniramine, terfenadine, and chlorpheniramine, and the like. Other antihistamines are represented by, but are not limited to—suitable salts of chlorcyclizine, clemastine fumarate, pyrilamine maleate, cetirizine hydrochloride, astemizole, loratadine, dexchlorpheniramine, fexofenadine, levocetrizine, promethazine, desloratadine, hydroxyzine, pheniramine, dipheniramine, acrivastine azelastine, ebastine, mizolastine and the like.

In another embodiment, synthetic mosquito repellent agent N, N-diethyl-3-methyl-benzamide, also called DEET is used. Other examples of synthetic mosquito repellent are—picaridin (butan-2-yl 2-(2-hydroxyethyl)piperidine-1-carboxylate), N, N-diethyl-benzamide, IR3535 (3-[N-butyl-N-acetyl]-aminopropionic acid, ethyl ester), dimethyl phthalate, metofluthrin, permethrin, diethyl carbate, ethyl hexanediol and like.

In another embodiment of the inevention, hydrocortisone is used as an anti-inflammatory agent. Other anti-inflammatory actives are selected from one or more of but not limited to: beclomethasone dipropionate, betamethasone, budesonide, dexamethasone, methylprednisolone, prednisolone, prednisone and triamcinolone.

Following are the key advantages of the disclosed composition:
1. The formulation is safe, eco-friendly,
2. It easy to use and it maximizes the repellency power against mosquito.
3. The product is cheap and it uses many natural active ingredients.
4. Topical powder formulation for mosquito repellent can be used in other place such as houses, restaurants, parks. One can spray the powder on the bed sheet and need not apply on the body.

With the following examples, one skilled in the art, can understand and use the disclosed composition.

### Example 1

Table 2 lists the composition of the topical mosquito repellent powder Formulation #1.

TABLE 2
Composition of the topical mosquito repellent
powder Formulation # 1.

| Ingredients | Quantity % |
|---|---|
| Mustard oil | 2 |
| Eucalyptus oil | 3 |
| Ethanol | 6 |
| Calcium silicate | 24 |
| Fragrances | 0.5 |
| Talc | 64.5 |

Weigh accurate quantity of mustard oil, eucalyptus oil and mix well. Dissolve the mixture of oils in ethanol. Mix this ethanolic solution with calcium silicate.

Mix well the mixture of oils with calcium silicate and talc. Air dry and then pass through a fine mesh sieve.

### Example 2

In the Formulation #2, diphenhydramine HCl is added to take care of allergic reactions (Table 3).

TABLE 3
Composition of the topical mosquito repellent
powder Formulation # 2.

| Ingredients | Quantity % |
|---|---|
| Mustard oil | 2 |
| Citronella oil | 1.5 |
| Neem oil | 1.5 |
| Ethanol | 6 |
| Calcium silicate | 19 |
| Diphenhydramine HCl | 1 |
| Hydroxypropyl β-cyclodextrin | 6 |
| Fragrances | 0.7 |
| Talc | 62.3 |

Part-1 Weigh accurate quantity of mustard oil, citronella oil, neem oil and mix well. Dissolve the mixture of oils in ethanol. Mix this solution with calcium silicate.

Part-2 Mix Talc, diphenydramine and Hydroxypropyl β-cyclodextrin.

Finally mix both parts 1 and 2 very well. Air dry to evaporate alcohol and pass through a fine mesh sieve.

### Example 3

Formulation #3 (formulation containing DEET) has been listed in Table 4.

TABLE 4
Composition of the topical mosquito repellent
powder Formulation # 3.

| Ingredients | Quantity % |
|---|---|
| Mustard oil | 0.87 |
| Pine oil | 1.12 |
| Neem oil | 1.26 |
| Ethanol | 6.06 |
| Eucalyptus oil | 1.26 |
| Calcium silicate | 18.94 |
| DEET | 0.89 |
| Sulfabutylether β-cyclodextrin | 6.06 |
| Fragrances | 0.4 |
| Talc | 63.2 |

Part-1 Weigh accurate quantity of mustard oil, pine oil, neem oil, DEET and mix well. Dissolve the mixture of oils and DEET in ethanol. Mix this solution with calcium silicate.

Part-2 Mix Talc and Hydroxylpropyl β-cyclodextrin.

Finally mix both parts 1 and 2 very well, air dry the product and pass through fine mesh sieve.

### Example 4

Composition of Formulation #4 (formulation containing DEET and picaridine combination) has been listed in Table 5.

TABLE 5
Composition of the topical mosquito repellent
powder Formulation # 4.

| Ingredients | Quantity % |
|---|---|
| Mustard oil | 1.5 |
| Pine oil | 1.5 |
| Geranium oil | 1 |
| Ethanol | 6 |
| Calcium silicate | 16 |
| Picardin | 2 |
| DEET | 3 |
| β-cyclodextrin | 6 |
| Fragrances | 0.5 |
| Talc | 62.5 |

Part-1 Weigh accurate quantity of mustard oil, pine oil, geranium oil, DEET, picaridine and mix well. Load the mixture of oils, DEET and Picaridin in ethanol. Mix this solution with calcium silicate.

Part-2 Mix Talc and β-cyclodextrin.

Finally mix both parts 1 and 2 very well, air dry and pass through fine mesh sieve.

### Example 5

Table 6 lists the composition of Formulation #5 (formulation containing combination of oils and diphendramine).

TABLE 6
Composition of the topical mosquito repellent
powder Formulation # 5.

| Ingredients | Quantity % |
|---|---|
| Mustard oil | 2.5 |
| Pine oil | 1.5 |
| Neem oil | 1.5 |
| Ethanol | 6 |
| Diphenhydramine HCl | 1.5 |
| Calcium silicate | 16 |
| DEET | 4 |
| β-cyclodextrin | 7 |
| Talc | 60 |

The manufacturing process is similar to described in previous examples.

### Example 6

Table 7 lists the composition of Formulation #6 (formulation containing combination of diphenhydramine and hydrocortisone).

TABLE 7
Composition of the topical mosquito repellent
powder Formulation # 6.

| Ingredients | Quantity % |
|---|---|
| Mustard oil | 2 |
| Pine oil | 1 |
| Neem oil | 1 |
| Eucalyptus oil | 1 |
| Citronella oil | 1 |
| Ethanol | 6 |
| Diphenhydramine HCl | 1.5 |
| Calcium silicate | 15 |
| Picaridin | 2 |
| DEET | 2 |
| Hydrocortisone | 1 |
| β-cyclodextrin | 6.5 |
| Talc | 60 |

### Example 7

Table 8 lists the composition of Formulation #7

TABLE 8
Composition of the topical mosquito repellent
powder Formulation # 7.

| Ingredients | Quantity % |
|---|---|
| Calcium silicate | 25 |
| fragrances | 1 |
| Talc | 74 |

### Example 8

Table 9 lists the composition of Formulation #8

TABLE 9
Composition of the topical mosquito repellent
powder Formulation # 8.

| Ingredients | Quantity % |
|---|---|
| Sulfabutylether betacyclodextrin | 10 |
| Fragrances | 1 |
| Talc | 89 |

The manufacturing procedure for Formulation #6 is same as mentioned in other examples earlier.

In all the examples, even though ethanol is listed in the initial composition, it evaporates during the air drying step. Thus, the final composition does not contain ethanol or if present, it is in small quantity.

A product from this patent application was tested in an entomology lab. In the Hand-in-Cage experiment, the forearm of a volunteer was exposed to hungry female mosquitoes placed in a cage. In a control experiment, no mosquito repellent was applied on the forearm. As soon as the forearm was placed in the cage through the glove-hole, mosquitoes landed on the forearm and started to bite. To test active products, a male and a female volunteer applied the powder mosquito repellent formulation on their forearms. They placed the forearms in the cage with hungry female mosquitoes. For both volunteers, hungry female mosquitoes did not even land on their forearm and there was no question of biting.

Formulations #3, #6 and #8 were applied on the arms and legs of other set of volunteers. They went out for a walk in an outdoor area where there were mosquitoes. All formulations repelled mosquitoes and the volunteers were not bitten by mosquitoes.

These formulations can be applied to on the bed sheets, pillow, and on night dress. If people are using a sleeping bag outdoors, they can apply the powder mosquito repellent formulation on the sleeping bag or on the tent too.

The mosquito repellent powder is easy to clean. The exposed objects or skin can be cleaned by soap and warm water.

Overall, this patent application claims a method for repelling insects from the skin of a subject comprising the step of topically applying a powder insect repellent composition to the skin of the subject. While specific examples have been presented here, various modifications can be made and the disclosure is not limited to the examples shown in this patent application. Overall, the formulations presented in the patent applications would be safer than currently available mosquito repellent formulations based on two aspects—1. Selection and lesser percent of actives and the selection of powder as a delivery system. Lesser percent of actives are absorbed through the skin when applied as in a powder form due to reduced surface contact and lesser increase in the permeation of actives from the powder. The actives are either adsorbed on the surface of powder particles or absorbed in the powder particles. There are hundreds of types of mosquitoes and the compositions in this patent application have potential to be effective against all the species of mosquitoes observed in the world. The formulation was observed to be very effective when tested in the entomology lab and tested in the field with mosquitoes. The formulation described in the present patent application is effective against mosquitoes but can also be used to repel commonly observed house-flies, fruit-flies, chiggers, fleas and ticks. The compositions contain fragrances to make the formulations pleasing to smell. They also can contain some colorants such as light pink color to make them attractive.

What is claimed is:

1. A method for repelling insects from the skin of a subject comprising the step of topically applying a powder insect repellent composition to the skin of the subject.

2. The method of claim 1 wherein the powder insect repellent composition comprises at least one of the following: talc, calcium silicate, and cyclodextrin.

3. The method of claim 2 wherein the powder insect repellent composition comprises talc present in a concentration of from about 0.01% to about 95% w/w.

4. The method of claim 2 wherein the powder insect repellent composition comprises calcium silicate present in a concentration of from about 0.01% to about 40% w/w.

5. The method of claim 2 wherein the powder insect repellent composition comprises cyclodextrin in a concentration of from about 0.01% to about 40% w/w.

6. The method of claim 2 wherein the powder insect repellent composition comprises at least two of: talc, calcium silicate, and cyclodextrin.

7. The method of claim 2 wherein the powder insect repellent composition comprises talc, calcium silicate, and cyclodextrin.

8. The method of claim 1 wherein the powder insect repellent composition comprises an insect repellent that is a natural oil.

9. The method of claim 1 wherein the powder insect repellent composition comprises a plurality of different insect repellents, each insect repellent being a natural oil.

10. The method of claim 1 wherein the powder insect repellent composition comprises DEET.

11. The method of claim 1 wherein the powder insect repellent composition comprises picaridin.

12. The method of claim 1 wherein the powder insect repellent composition comprises solid powder particles coated with at least one liquid insect repellent.

13. The method of claim 12 wherein each at least one liquid insect repellent comprises a natural oil.

14. The method of claim 13 wherein each natural oil comprises at least one of the following: mustard, eucalyptis, pine, peppermint, menthol, camphor, garlic, wintergreen, rose geranium, litsea cubeba, lemongrass, pulegone, oleoresin capsicum, neem, citronella, and catnip.

15. The method of claim 12 wherein the solid powder particles are particles of at least one of the following: talc, calcium silicate, and cyclodextrin.

16. The method of claim 1 wherein the powder insect repellent composition comprises solid powder particles coated with at least one of the following: DEET and picaridin.

17. The method of claim 16 wherein the solid powder particles are particles of at least one of the following: talc, calcium silicate, and cyclodextrin.

18. The method of claim 17 wherein the solid powder particles comprise from about 0.01% to about 40# w/w of the powder insect repellent composition and the solid powder particles comprise at least one of the following: talc, calcium silicate, and cyclodextrin.

19. The method of claim 1 wherein the powder insect repellent composition comprises an antihistamine.

20. The method of claim 1 wherein the powder insect repellent composition comprises at least one of the following: a fragrance and a colorant.
